(19) United States
(12) Patent Application Publication
(10) Pub. No.: US 2024/0039012 A1
(43) Pub. Date: Feb. 1, 2024

(54) DISCRETE MICROCHANNELS AND MICROSTRUCTURES EMBEDDED IN METAL FOAM GAS DIFFUSION LAYER FOR PEM FUEL CELLS

(71) Applicant: Toyota Motor Engineering & Manufacturing North America, Inc., Plano, TX (US)

(72) Inventors: Yuqing Zhou, Ann Arbor, MI (US); Gaohua Zhu, Ann Arbor, MI (US); Ercan M Dede, Ann Arbor, MI (US); Liang Wang, Saline, MI (US); Hongfei Jia, Ann Arbor, MI (US); Debasish Banerjee, Ann Arbor, MI (US)

(73) Assignees: Toyota Motor Engineering & Manufacturing North America, Inc., Plano, TX (US); Toyota Jidosha Kabushiki Kaisha, Aichi Prefecture (JP)

(21) Appl. No.: 17/815,047

(22) Filed: Jul. 26, 2022

(51) Int. Cl. H01M 8/0265; H01M 8/1004; H01M 8/0232

(52) U.S. Cl. CPC H01M 8/0265; H01M 8/1004; H01M 8/0232; H01M 2008/1095

(57) ABSTRACT

A fuel cell (FC) assembly having a stack that includes a bipolar plate and a gas diffusion layer (GDL) composed of a microporous metal foam having embedded therein a plurality of discrete microchannels or a plurality of discrete microstructures.

### TECHNICAL FIELD

Embodiments relate generally to a fuel cell (FC) assembly having a stack that includes a gas diffusion layer (GDL) composed of a microporous metal foam having embedded therein a plurality of discrete microchannels or a plurality of discrete microstructures.

### BACKGROUND

Contemporary fuel cell vehicles generally include one or more fuel cell modules comprising a plurality of fuel cells (FC) arranged in a stack formation. Each FC in the stack may have a structure in the form of a membrane electrode assembly (MEA). The MEA may comprise a polymer-electrolyte membrane (PEM) cell interposed between a first electrode (e.g., an anode) and a second electrode (e.g., a cathode). Contemporary PEMFC stacks often use a carbon-based microporous gas diffusion layer (GDL). Alternatively, the use of metal foam GDL enhances thermal, electrical, and mechanical strength performance with enhanced contact resistance and corrosion resistance.

Accumulation of water at the cathode side can inhibit oxygen transport to the MEA, thereby resulting in inhomogeneous and discontinuous distribution of reactants over the active cathode catalyst layer. Accordingly, water management in the PEMFC is of some concern.

### BRIEF SUMMARY

One or more embodiments set forth, described, and/or illustrated herein present a flow field structures using discrete microchannels or microstructures embedded inside a microporous metal foam GDL to achieve enhanced electrochemical reaction and water management performance of the PEMFC. In particular, discrete microchannels or microstructures in an embedded flow field configuration facilitate enhanced overall operational performance of the PEMFC, particularly as it relates to reaction uniformity and water management.

In one or more example embodiments, the discrete, embedded microchannels and the discrete, embedded microstructures have an irregular size that facilitate cross flows among neighboring microchannels due to pressure differentials. This configuration, in turn, further enhances the reactant distribution in the out-of-plane direction and water removal performance. The overall size and orientation of the discrete, embedded microchannels and the discrete, embedded microstructures wall features affect the resulting permeability of the equivalent porous media. As such, the size, orientation, and hence, the permeability, may be tuned to further optimize the operational performance of the PEMFC.

In accordance with one or more embodiments, an FC assembly such as, for example, a PEMFC assembly, comprises one or more of the following: a bipolar plate having a bipolar plate body; and a GDL, composed of a microporous metal foam, and operable for direct contact with the bipolar plate body, the GDL having a fluid flow field defined by a plurality of discrete, embedded microchannels that are defined by permeable flow channel walls and permeable flow channel surfaces. In accordance with each example FC assembly, the permeability of the flow channel walls and the flow channel surfaces facilitate fluid flow therethrough.

In accordance with the example FC assembly, the microporous metal foam comprises one or more of titanium, a titanium alloy, iron, steel, stainless steel, nickel, a nickel alloy, aluminum, an aluminum alloy, copper, and a copper alloy.

In accordance with the example FC assembly, the discrete, embedded microchannels have varying shapes with respect to each other. In one example, the shapes are irregular. In another example, the shapes are regular such as circular and/or rotated elliptical. In a further example, the shapes are a combination of regular and irregular shapes.

In accordance with the example FC assembly, the discrete, embedded microchannels have varying sizes with respect to each other.

In accordance with the example FC assembly, the discrete, embedded microchannels have varying channel lengths with respect to each other.

In accordance with the example FC assembly, the discrete, embedded microchannels have varying channel widths with respect to each other

In accordance with the example FC assembly, the discrete, embedded microchannels have varying orientations with respect to each other.

In accordance with one or more embodiments, an FC assembly comprises one or more of the following: a bipolar plate body; and a GDL, composed of a microporous metal foam, adjacent to and in direct contact with the bipolar plate body, the GDL having a fluid flow field of microchannels defined by a plurality of discrete, embedded microstructures.

In accordance with the example FC assembly, the microporous metal foam comprises one or more of titanium, a titanium alloy, iron, steel, stainless steel, nickel, a nickel alloy, aluminum, an aluminum alloy, copper, and a copper alloy.

In accordance with the example FC assembly, the discrete, embedded microstructures have varying shapes with respect to each other. In one example, the shapes are irregular. In another example, the shapes are regular such as circular and/or rotated elliptical. In a further example, the shapes are a combination of regular and irregular shapes.

In accordance with the example FC assembly, the discrete, embedded microstructures have varying sizes (e.g., area, volume, etc.) with respect to each other.

In accordance with the example FC assembly, the discrete, embedded microstructures have varying lengths with respect to each other.

In accordance with the example FC assembly, the discrete, embedded microstructures have varying orientations with respect to each other.

In accordance with one or more embodiments, a FC assembly, such as, for example, a PEMFC assembly, comprises one or more of the following: an MEA; a bipolar plate having a bipolar plate body; and a GDL, interposed between the MEA and the bipolar plate body, and composed of a microporous metal foam having a fluid flow field defined by a plurality of discrete, embedded microchannels.

In accordance with the example FC assembly, the microporous metal foam comprises one or more of titanium, a titanium alloy, iron, steel, stainless steel, nickel, a nickel alloy, aluminum, an aluminum alloy, copper, and a copper alloy.

In accordance with the example FC assembly, the discrete, embedded microchannels have varying shapes with respect to each other. In one example, the shapes are irregular. In another example, the shapes are regular such as circular and/or rotated elliptical. In a further example, the shapes are a combination of regular and irregular shapes.

In accordance with the example FC assembly, the discrete, embedded microchannels have varying sizes with respect to each other.

In accordance with the example FC assembly, the discrete, embedded microchannels have varying channel lengths with respect to each other.

In accordance with the example FC assembly, the discrete, embedded microchannels have varying channel widths with respect to each other

In accordance with the example FC assembly, the discrete, embedded microchannels have varying orientations with respect to each other.

In accordance with one or more embodiments, a method of manufacturing an FC assembly comprises one or more of the following: forming an MEA and a bipolar plate having a bipolar plate body; and forming a GDL interposed between the MEA and the bipolar plate body, and which is composed of a microporous metal foam having a fluid flow field defined by a plurality of discrete, embedded microchannels that are defined by flow channel walls and flow channel surfaces.

In accordance with the example method, the microporous metal foam comprises one or more of titanium, a titanium alloy, iron, steel, stainless steel, nickel, a nickel alloy, aluminum, an aluminum alloy, copper, and a copper alloy.

In accordance with the example method, forming the GDL comprises forming the discrete, embedded microchannels with varying shapes with respect to each other. In one example, the shapes are irregular. In another example, the shapes are regular such as circular and/or rotated elliptical. In a further example, the shapes are a combination of regular and irregular shapes.

In accordance with the example method, forming the GDL comprises forming the discrete, embedded microchannels with varying sizes with respect to each other.

In accordance with the example method, forming the GDL comprises forming the discrete, embedded microchannels with varying channel lengths with respect to each other.

In accordance with the example method, forming the GDL comprises forming the discrete, embedded microchannels with varying channel widths with respect to each other.

In accordance with the example method, forming the GDL comprises forming the discrete, embedded microchannels with varying orientations with respect to each other.

In accordance with one or more embodiments, a method of manufacturing an FC assembly comprises one or more of the following: forming an MEA and a bipolar plate having a bipolar plate body; and forming a GDL interposed between the MEA and the bipolar plate body, and which is composed of a microporous metal foam having a fluid flow field of microchannels defined by a plurality of discrete, embedded microstructures.

In accordance with the example method, the microporous metal foam comprises one or more of titanium, a titanium alloy, iron, steel, stainless steel, nickel, a nickel alloy, aluminum, an aluminum alloy, copper, and a copper alloy.

In accordance with the example method, forming the GDL comprises forming the discrete, embedded microstructures with varying shapes with respect to each other. In one example, the shapes are irregular. In another example, the shapes are regular such as circular and/or rotated elliptical. In a further example, the shapes are a combination of regular and irregular shapes.

In accordance with the example method, forming the GDL comprises forming the discrete, embedded microstructures with varying sizes with respect to each other.

In accordance with the example method, forming the GDL comprises forming the discrete, embedded microstructures with varying lengths with respect to each other.

In accordance with the example method, forming the GDL comprises forming the discrete, embedded microstructures with varying widths with respect to each other.

In accordance with the example method, forming the GDL comprises forming the discrete, embedded microstructures with varying orientations with respect to each other.

### BRIEF DESCRIPTION OF THE SEVERAL VIEWS OF THE DRAWINGS

The various advantages of the one or more embodiments will become apparent to one skilled in the art by reading the following specification and appended claims, and by referencing the following drawings, in which:

FIG. 1 illustrates a configuration of a PEMFC, in accordance with one or more embodiments set forth, shown, and described herein.

FIG. 2 illustrates a top view of an example fluid flow field of a microporous metal foam GDL for a PEMFC, the flow field structure defined by a plurality of discrete, embedded microchannels.

FIG. 3 illustrates a perspective view of an example fluid flow field of a microporous metal foam GDL for a PEMFC, the flow field structure defined by a plurality of discrete, embedded microchannels.

FIG. 4 illustrates a top view of an example fluid flow field of a microporous metal foam GDL for a PEMFC, the flow field structure defined by a plurality of discrete, embedded microstructures.

FIG. 5 illustrates a perspective view of an example fluid flow field of a microporous metal foam GDL for a PEMFC, the flow field structure defined by a plurality of discrete, embedded microstructures.

FIG. 6 illustrates a top view of an example fluid flow field of a microporous metal foam GDL for a PEMFC, the flow field structure defined by a plurality of discrete, embedded microchannels having regular patterns of geometric figures.

FIG. 7 illustrates a top view of an example fluid flow field of a microporous metal foam GDL, the flow field structure being defined by a plurality of discrete, embedded microstructures having regular patterns of geometric figures.

FIG. 8 illustrates a plot of normalized voltage versus normalized current density for a PEMFC having with a microporous metal foam GDL, in accordance with one or more embodiments set forth, shown, and described herein.

FIG. 9 illustrates a plot of normalized power density versus normalized current density for a PEMFC with a microporous metal foam GDL, in accordance with one or more embodiments set forth, shown, and described herein.

FIGS. 10 through 13 respectively illustrate a schematic diagram of example methods of manufacturing a PEMFC, in accordance with one or more embodiments set forth, shown, and described herein.

### DETAILED DESCRIPTION

One or more embodiments set forth, described, and/or illustrated herein present a flow field structures using discrete microchannels or microstructures embedded inside a microporous metal foam GDL to achieve enhanced electrochemical reaction and water management performance of the PEMFC. In such a PEMFC, water produced as a byproduct of the chemical reaction, can be temporarily trapped inside the discrete microchannels, resulting in increased wettability of the PEMFC. The trapped water can later be cleared as the PEMFC condition changes. This localized behavior helps prevent or otherwise minimizes membrane dry-out otherwise observed in a configuration of flat bipolar plates without flow fields inside a metal foam GDL.

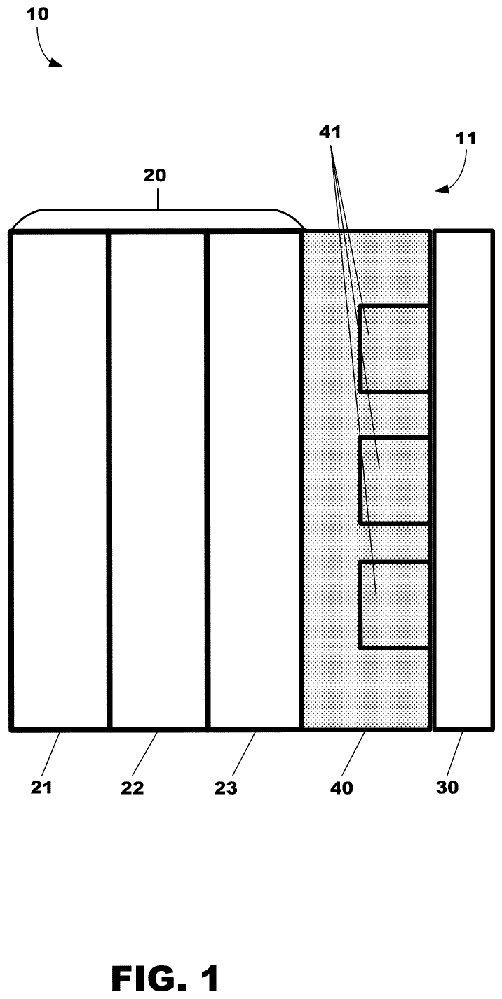

In the illustrated example embodiment of FIG. 1, an PEMFC assembly 10 having a multi-layer electrolyte structure that includes an anode region and a cathode region 11. The PEMFC assembly 10 comprises an MEA layer 20 includes a polymer-electrolyte membrane 22 interposed between an anode side 21 and a cathode side 23. In accordance with one or more embodiments, the MEA layer includes one or more anode catalyst layers (not illustrated) and/or one or more cathode catalyst layers (not illustrated).

The cathode region 11 includes a fluid flow system comprising a bipolar plate having a substantially flat bipolar plate body 30 and a microporous metal foam GDL 40 having one or more flow channels 41. In accordance with one or more embodiments, the microporous metal foam GDL 40 is composed of titanium, a titanium alloy, iron, steel, stainless steel, nickel, a nickel alloy, aluminum, an aluminum alloy, copper, and a copper alloy. Embodiments, however, are not limited thereto. This disclosure contemplates the microporous metal foam GDL 40 being composed of any metal that falls within the spirit and scope of the principles of this disclosure set forth, illustrated, and/or described herein. Alternatively or additionally, the microporous metal foam GDL 40 may be provided with one or more coatings to provide enhanced fluid flow distribution. In accordance with one or more embodiments, a microporous layer (not illustrated) may be arranged at an interface between the cathode 23 and the microporous metal foam GDL 40. In accordance with one or more embodiments, the flow channels 41 are hollow flow channels, i.e., the flow channels 41 are not filled or occupied by a filler material and/or an adhesive. In accordance with one or more embodiments, the flow channels 41 are spaced apart from the cathode 23 and positioned adjacent to the bipolar plate body 30.

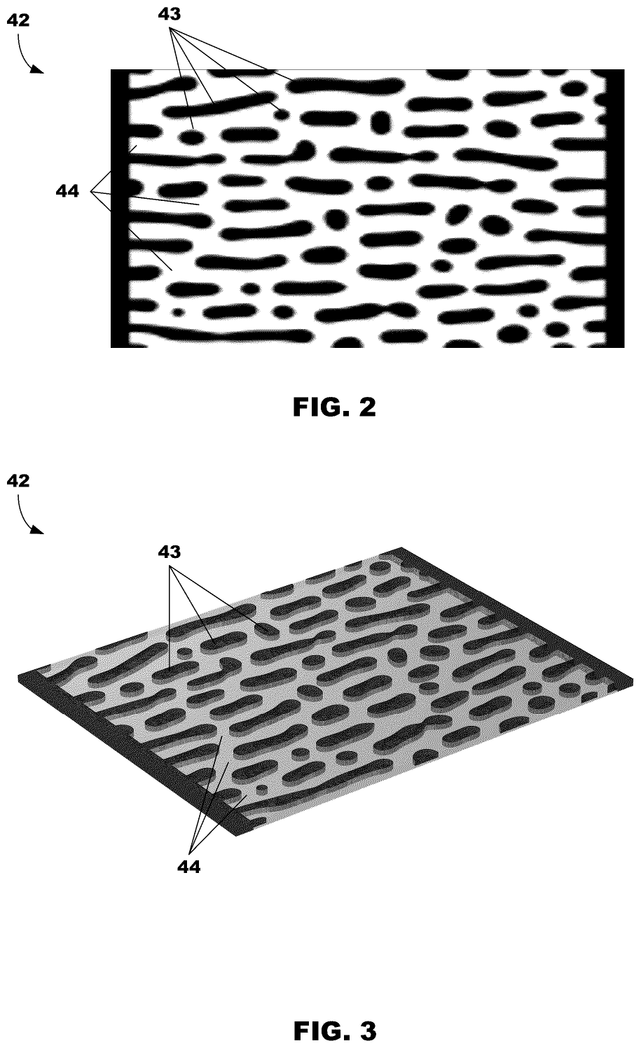

As illustrated in FIGS. 2 and 3, the microporous metal foam GDL 40 has embedded therein a plurality of discrete, embedded microchannels 43 (fluid domain denoted in darkened areas) that themselves are defined by permeable flow walls 44 (denoted in lightened areas). The fluid flow field 42 defined by the plurality of discrete, embedded microchannels 43 extends from an inlet region to an outlet region of the PEMFC assembly 10. In the illustrated embodiment, the discrete, embedded microchannels 43 have an irregular cross-section or geometric shape of varying sizes (e.g., area, volume, etc.) and varying spatial orientations. Embodiments, however, are not limited thereto. For instance, the operational performance of the PEMFC assembly 10 may be optimized by having a fluid flow field 42 defined by discrete, embedded microchannels 43 with a regular cross-section or geometric shape, and discrete, embedded microchannels 43 with an irregular cross-section or geometric shape.

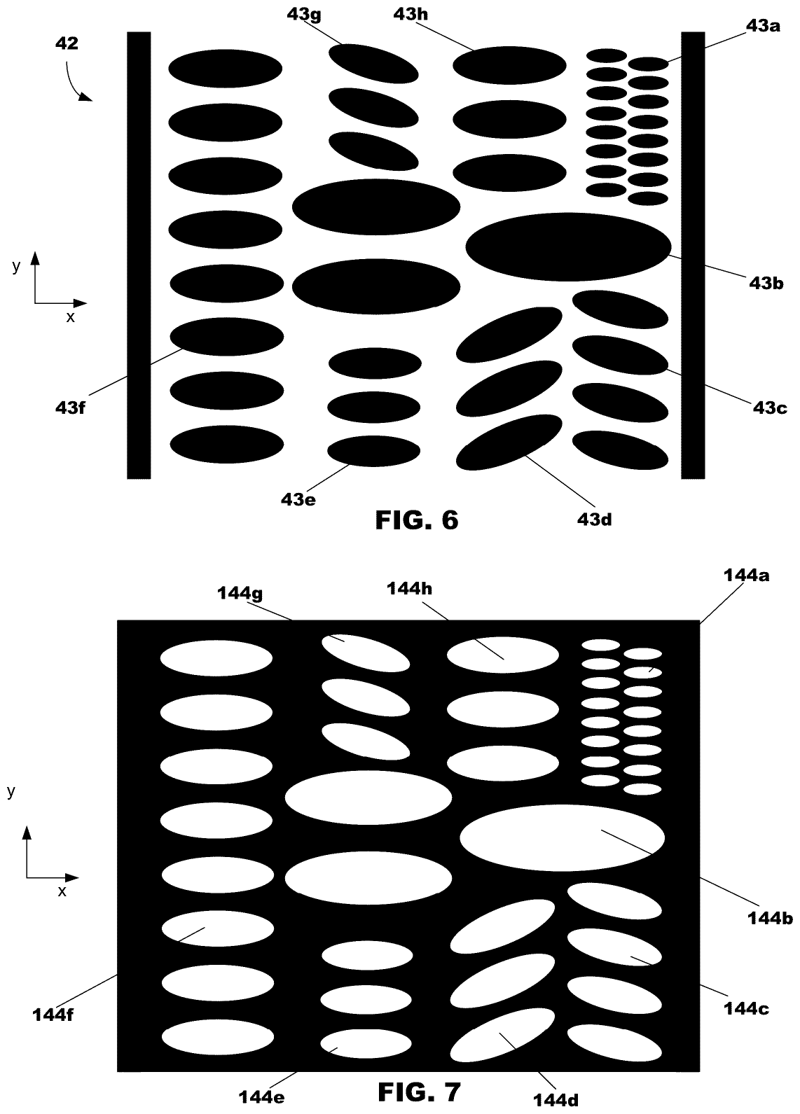

As illustrated in FIG. 6, the discrete, embedded microchannels 43 of the fluid flow field 42 have a regular cross-section or geometric shape of elliptical shapes. Such a regular shape includes, but is not limited to, circular shapes and rotated elliptical shapes. In the illustrated example, the operational performance of the PEMFC assembly 10 may also be optimized by having a fluid flow field 42 defined by a plurality of discrete, embedded microchannels 43a-h of varying sizes (e.g., area, volume, etc.) with respect to each other, varying channel lengths with respect to each other, varying channel widths with respect to each other, and varying channel orientations with respect to each other.

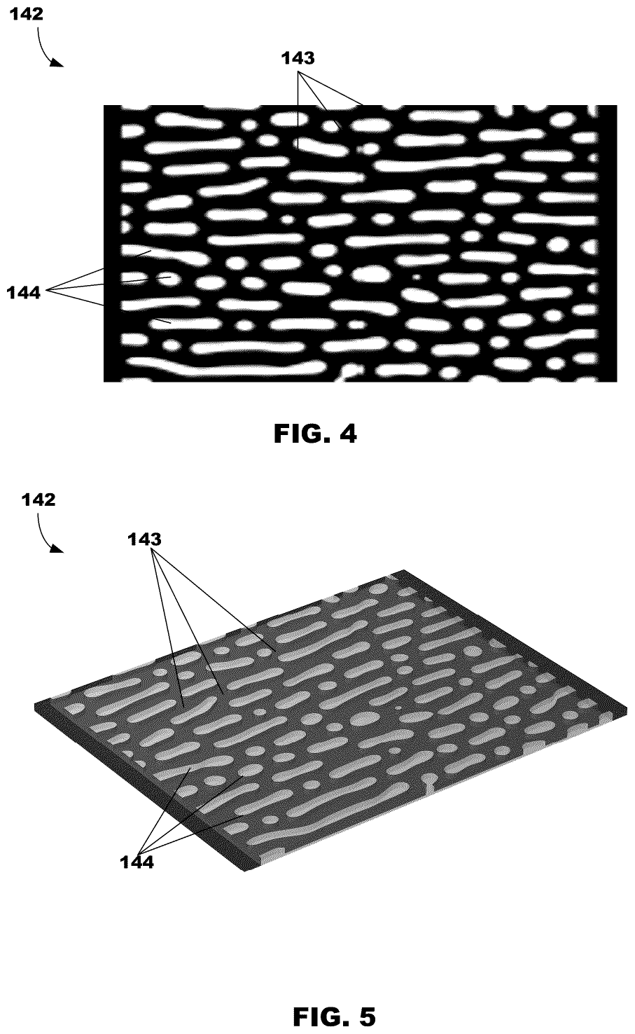

As illustrated in FIGS. 4 and 5, alternatively, the microporous metal foam GDL 140 has embedded therein a plurality of discrete, embedded microstructures 144 (denoted in lightened areas) that define a plurality of microchannels 143 (fluid domain denoted in darkened areas). The fluid flow field 142 defined by the plurality of discrete, embedded microstructures 144 extends from an inlet region to an outlet region of the PEMFC assembly 10. In the illustrated embodiment, the discrete, embedded microstructures 144 have an irregular cross-section or geometric shape of varying sizes (e.g., area, volume, etc.) and varying spatial orientations. Embodiments, however, are not limited thereto. For instance, the operational performance of the PEMFC assembly 10 may also be optimized by having a fluid flow field 42 defined by discrete, embedded microstructures 144 with a regular cross-section or geometric shape, and discrete, embedded microstructures 144 with an irregular cross-section or geometric shape.

As illustrated in FIG. 7, the discrete, embedded microstructures 144 of the fluid flow field 162 have a regular cross-section or geometric shape of 2D elliptical shapes. Such a regular shape includes, but is not limited to, circular 2D shapes and elliptical 2D shapes. In the illustrated example, the operational performance of the PEMFC assembly 10 may also be optimized by having a fluid flow field 42 defined by a plurality of discrete, embedded microstructures 144a-h of varying sizes (e.g., area, volume, etc.) with respect to each other, varying wall lengths with respect to each other, varying widths with respect to each other, and varying wall orientations with respect to each other.

In operation of the PEMFC assembly 10, a first fuel reactant comprising hydrogen (H₂) gas is supplied via a fuel supply source (e.g., a high-pressure hydrogen storage tank) and a second fuel reactant comprising oxygen (O₂) gas (e.g., O₂ in air) supplied via a stream of compressed air to flow through the flow channels 41 of microporous metal foam GDL 40. A portion of the H₂ gas flowing through the flow channels is catalyzed into H+ ions plus electrons (e.g., via the anode catalyst layer) and a portion of the O₂ gas flows through the microporous metal foam GDL 40 to the cathode side 23. The electrons flow through an external electrical circuit (not illustrated) to the cathode side 23 and react with the O₂ to form O₂— ions (e.g., via the cathode catalyst layer) and the H+ ions diffuse through the polymer-electrolyte membrane 22 to the cathode side 23 and react with the O₂— ions to form H₂O (water) as a byproduct. The water is transported out of the PEMFC assembly 10 with the flow of air, with the microporous metal foam GDL 40 providing enhanced water removal management and increased power density compared to conventional GDL configurations.

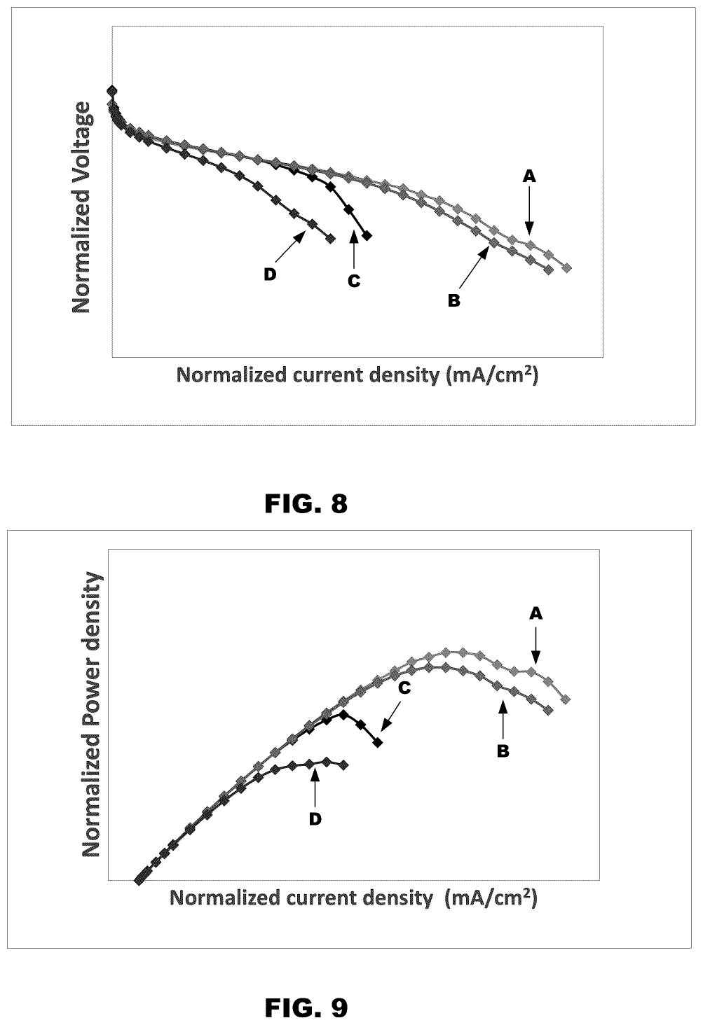

As illustrated in FIG. 8, a plot of normalized voltage versus normalized current density is illustrated, while FIG. 9 illustrates a plot of normalized power density versus normalized current density. The plot includes a PEMFC assembly “A” made in accordance with one or more embodiments having a configuration that includes a flat bipolar plate and a microporous metal foam GDL having a flow field structure defined by a plurality of discrete, embedded microchannels; a PEMFC assembly “B” having a configuration that includes a flat bipolar plate and a foam GDL having straight parallel channels; a state-of-the-art PEMFC assembly “C” having a configuration that includes a conventional carbon GDL and a bipolar plate flow field; and PEMFC assembly “D” having a configuration that includes a flat bipolar plate and a porous metal GDL without flow channels. The plot in FIG. 9 illustrates that the PEMFC assembly “A” made in accordance with one or more embodiments exhibited the greatest maximum power density and maximum current density when compared to the other PEMFC assembly designs.

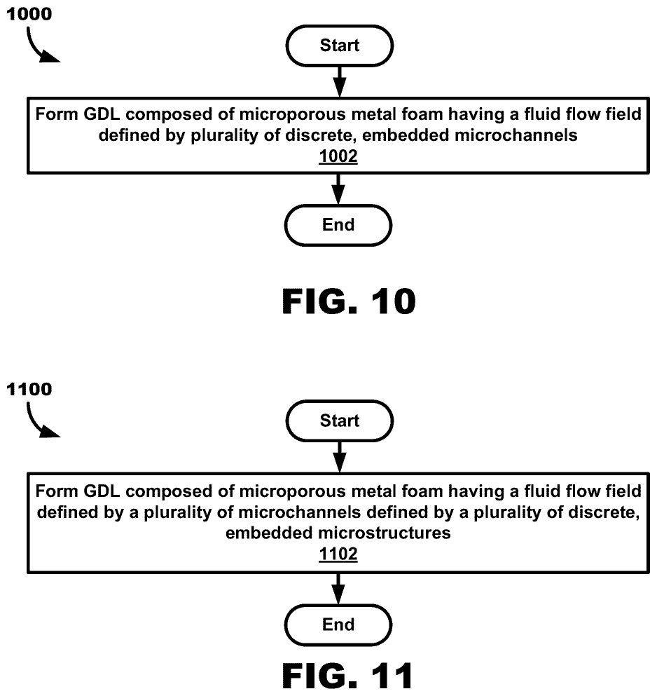

FIGS. 10 through 13 respectively illustrates a flowchart of example methods 1000, 1100, 1200, and 1300 of manufacturing a PEMFC assembly, in accordance with one or more embodiments. Each method 1000, 1100, 1200, and 1300 is to yield an optimized GDL composed of a microporous metal foam having a fluid flow field defined by a plurality of discrete, embedded microchannels or microstructures that yields enhanced uniform reaction performance water management performance by the PEMFC.

The flowchart of each method 1000, 1100, 1200, and 1300 corresponds in whole or in part to the schematic illustrations of FIGS. 1 through 9 as set forth, illustrated, and described herein.

As illustrated in FIG. 10, in the method 1000, illustrated processing block 1002 includes forming a GDL composed of a microporous metal foam having a fluid flow field of microchannels. The method 1000 can then terminate or end after execution of process block 1002.

As illustrated in FIG. 11, in the method 1100, illustrated processing block 1102 includes forming a GDL composed of a microporous metal foam having a fluid flow field of microchannels defined by a plurality of discrete, embedded microstructures. The method 1102 can then terminate or end after execution of process block 1102.

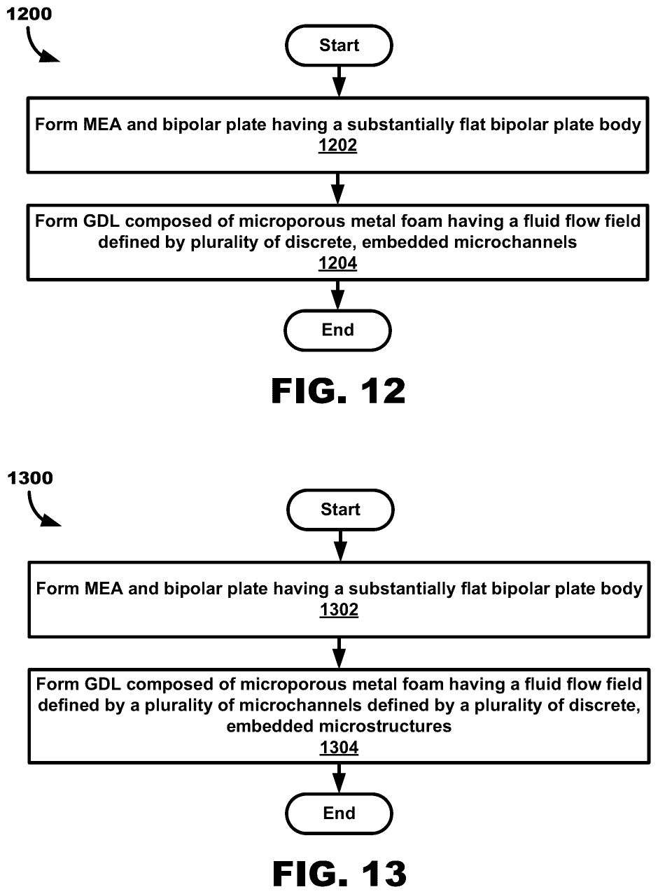

As illustrated in FIG. 12, in the method 1200, illustrated processing block 1202 includes forming a membrane electrode assembly (MEA) and a bipolar plate having a substantially flat bipolar plate body.

The method 1200 can then proceed to illustrated process block 1204, which includes forming a GDL, which is composed of a microporous metal foam, interposed between the MEA and the bipolar plate body and which is composed of a microporous metal foam. In accordance with process block 1204, forming the GDL comprises forming the GDL having a fluid flow field of microchannels. The method 1200 can then terminate or end after execution of process block 1204.

As illustrated in FIG. 13, in the method 1000, illustrated processing block 1302 includes forming a membrane electrode assembly (MEA) and a bipolar plate having a substantially flat bipolar plate body.

The method 1300 can then proceed to illustrated process block 1304, which includes forming a GDL, which is composed of a microporous metal foam, interposed between the MEA and the bipolar plate body and which is composed of a microporous metal foam. In accordance with process block 1304, forming the GDL comprises forming the GDL having a fluid flow field of microchannels defined by a plurality of discrete, embedded microstructures. The method 1300 can then terminate or end after execution of process block 1304.

The terms “coupled,” “attached,” or “connected” may be used herein to refer to any type of relationship, direct or indirect, between the components in question, and may apply to electrical, mechanical, fluid, optical, electromagnetic, electromechanical or other connections. In addition, the terms “first,” “second,” etc. are used herein only to facilitate discussion, and carry no particular temporal or chronological significance unless otherwise indicated.

Those skilled in the art will appreciate from the foregoing description that the broad techniques of the one or more embodiments can be implemented in a variety of forms. Therefore, while the embodiments are set forth, illustrated, and/or described in connection with particular examples thereof, the true scope of the embodiments should not be so limited since other modifications will become apparent to the skilled practitioner upon a study of the drawings, specification, and claims.

What is claimed is:

1. A fuel cell (FC) assembly, comprising:
a membrane electrode assembly (MEA);
a bipolar plate having a bipolar plate body; and
a gas diffusion layer (GDL), interposed between the MEA and the bipolar plate body, and composed of a microporous metal foam having a fluid flow field defined by a plurality of discrete, embedded microchannels.

2. The FC assembly of claim 1, wherein the microporous metal foam comprises one or more of titanium, a titanium alloy, iron, steel, stainless steel, nickel, a nickel alloy, aluminum, an aluminum alloy, copper, and a copper alloy.

3. The FC assembly of claim 1, wherein the discrete, embedded microchannels have varying 2D geometric shapes with respect to each other.

4. The FC assembly of claim 3, wherein the shapes are irregular 2D geometric shapes.

5. The FC assembly of claim 3, wherein the shapes are regular 2D geometric shapes.

6. The FC assembly of claim 1, wherein the discrete, embedded microchannels have varying sizes with respect to each other.

7. The FC assembly of claim 1, wherein the discrete, embedded microchannels have varying channel lengths with respect to each other.

8. The FC assembly of claim 1, wherein the discrete, embedded microchannels have varying spatial orientations with respect to each other.

9. A fuel cell (FC) assembly, comprising:
a membrane electrode assembly (MEA);
a bipolar plate having a bipolar plate body; and
a gas diffusion layer (GDL), interposed between the MEA and the bipolar plate body, and composed of a microporous metal foam having a fluid flow field of microchannels defined by a plurality of discrete, embedded microstructures.

10. The FC assembly of claim 9, wherein the microporous metal foam comprises one or more of titanium, a titanium alloy, iron, steel, stainless steel, nickel, a nickel alloy, aluminum, an aluminum alloy, copper, and a copper alloy.

11. The FC assembly of claim 9, wherein the discrete, embedded microstructures have varying 2D shapes with respect to each other.

12. The FC assembly of claim 11, wherein the shapes are irregular 2D shapes.

13. The FC assembly of claim 11, wherein the shapes are regular 2D shapes.

14. The FC assembly of claim 9, wherein the discrete, embedded microstructures have varying sizes with respect to each other.

15. The FC assembly of claim 9, wherein the discrete, embedded microstructures have varying lengths with respect to each other.

16. The FC assembly of claim 9, wherein the discrete, embedded microstructures have varying spatial orientations with respect to each other.

17. A method of manufacturing a PEMFC assembly, comprising:
forming a GDL composed of a microporous metal foam with a fluid flow field defined by a plurality of discrete, embedded microchannels.

18. The method of claim 17, wherein the discrete, embedded microchannels have varying shapes with respect to each other.

19. The method of claim 17, wherein the discrete, embedded microchannels have varying channel lengths with respect to each other.

20. The method of claim 17, wherein the discrete, embedded microchannels have varying orientations with respect to each other.
